(19) United States
(12) Patent Application Publication
(10) Pub. No.: US 2018/0229060 A1
(43) Pub. Date: Aug. 16, 2018

(54) FIRE SUPPRESSION SYSTEM

(71) Applicant: Marioff Corporation OY, Vantaa (FI)

(72) Inventors: Arto Huotari, Helsinki (FI); Antti Virkajarvi, Helsinki (FI)

(21) Appl. No.: 15/749,835

(22) PCT Filed: Aug. 27, 2015
(86) PCT No.: PCT/FI2015/050551

§ 371 Date: Feb. 2, 2018

(51) Int. Cl. A62C 3/00; A62C 99/00

(52) U.S. Cl. CPC A62C 3/006; A62C 99/0072

(57) ABSTRACT

A fire suppression system of an airflow system includes an airflow passage having an inlet and an outlet configured to provide an airflow path from the inlet to the outlet to exhaust air therethrough and a dispensing system is located within the airflow passage proximal to the inlet and configured to dispense a water mist discharge from within the airflow passage toward the inlet to form a water mist discharge sufficient to disrupt an airflow into the airflow passage.

### BACKGROUND

The subject matter disclosed herein generally relates to fire suppression systems and, more particularly, to sprayer arrangements in fire suppression systems.

In recent years, the development of high-efficiency cooking equipment with high energy input rates and the widespread use of vegetable oils with high burning temperature have increased potential risks to life and property loss. These fires may be difficult to extinguish and may be easily re-ignited when sufficient oxygen and temperatures are present. Further, due to the high temperatures, a fire may spread from a cook-top or other equipment into a duct or air vent, e.g., a hood and duct system. Even if a fire is suppressed, the high temperatures within a duct may enable a high temperature increase after the first is extinguished, which may enable the fire to restart. There is a significant need for improving fire safety and reducing the cost of protecting cooking areas through the introduction of new effective extinguishing and suppression systems.

### SUMMARY

According to one embodiment, a fire suppression system of an airflow system is provided. The fire suppression system includes an airflow passage having an inlet and an outlet configured to provide an airflow path from the inlet to the outlet to exhaust air therethrough and a dispensing system located within the airflow passage proximal to the inlet and configured to dispense a water mist discharge from within the airflow passage toward the inlet to form a water mist discharge sufficient to disrupt an airflow into the airflow passage.

In addition to one or more of the features described above, or as an alternative, further embodiments of the fire suppression system may include that the dispensing system comprises two passage-inlet nozzles located within the airflow passage and oriented to dispense the water mist discharge toward the inlet of the airflow passage.

In addition to one or more of the features described above, or as an alternative, further embodiments of the fire suppression system may include at least one airflow passage nozzle located within the airflow passage downstream of the inlet and configured to dispense water into the airflow passage.

In addition to one or more of the features described above, or as an alternative, further embodiments of the fire suppression system may include that the at least one passage-inlet nozzle is oriented to dispense water toward the inlet of the airflow passage.

In addition to one or more of the features described above, or as an alternative, further embodiments of the fire suppression system may include that the at least one passage-inlet nozzle is oriented to dispense water away from the inlet of the airflow passage.

In addition to one or more of the features described above, or as an alternative, further embodiments of the fire suppression system may include that the at least one passage-inlet nozzle comprises a first passage-inlet nozzle and a second passage-inlet nozzle, wherein the first passage-inlet nozzle is oriented to dispense water toward the inlet of the airflow passage and the second passage-inlet nozzle is oriented to dispense water away from the inlet of the airflow passage.

In addition to one or more of the features described above, or as an alternative, further embodiments of the fire suppression system may include that the at least one passage-inlet nozzle is oriented to dispense water toward both the inlet and the outlet of the airflow passage.

In addition to one or more of the features described above, or as an alternative, further embodiments of the fire suppression system may include a hood located external to the airflow passage at the inlet.

According to another embodiment, a method of suppressing a fire within an airflow passage is provided. The method includes detecting a fire within an airflow passage, activating a dispensing system, and dispensing a water mist discharge at least one of toward and away from an inlet of the airflow passage from within the airflow passage to form a water mist discharge sufficient to disrupt an airflow into the airflow passage. The dispensing system is located proximal to the inlet of the airflow passage.

In addition to one or more of the features described above, or as an alternative, further embodiments of the method may include that the dispensing system comprises two passage-inlet nozzles located proximal to the inlet and oriented to dispense the water mist discharge.

In addition to one or more of the features described above, or as an alternative, further embodiments of the method may include dispensing water into the airflow passage from at least one airflow passage nozzle located within the airflow passage.

In addition to one or more of the features described above, or as an alternative, further embodiments of the method may include that the at least one passage-inlet nozzle is oriented to dispense water toward the inlet.

In addition to one or more of the features described above, or as an alternative, further embodiments of the method may include that the at least one passage-inlet nozzle is oriented to dispense water away from the inlet.

In addition to one or more of the features described above, or as an alternative, further embodiments of the method may include that the at least one passage-inlet nozzle comprises a first passage-inlet nozzle and a second passage-inlet nozzle, wherein the first passage-inlet nozzle is oriented to dispense water toward the inlet and the second passage-inlet nozzle is oriented to dispense water away from the inlet.

In addition to one or more of the features described above, or as an alternative, further embodiments of the method may include that the at least one passage-inlet nozzle is oriented to dispense water both toward the inlet and away from the inlet.

Technical effects of embodiments of the present disclosure include a spray arrangement for fire suppression in an airflow passage. Further technical effects of embodiments include providing two spray nozzles configured to supply a water mist discharge at an air inlet of an airflow passage to disrupt a flow of air into the airflow passage, to reduce the amount of oxygen that may be present in the airflow passage, and to reduce the temperature of the air within the airflow passage.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an airflow passage that may employ embodiments disclosed herein;

FIG. 2A is schematic plan view of a dispensing system arrangement of a fire suppression system in accordance with a first embodiment;

FIG. 2B is a schematic side view of the dispensing system arrangement of the fire suppression system of FIG. 2A;

FIG. 2C is a schematic front view of the dispensing system arrangement of the fire suppression system of FIG. 2A;

FIG. 3A is schematic plan view of a dispensing system arrangement of a fire suppression system in accordance with a second embodiment;

FIG. 3B is a schematic side view of the dispensing system arrangement of the fire suppression system of FIG. 3A;

FIG. 3C is a schematic front view of the dispensing system arrangement of the fire suppression system of FIG. 3A;

FIG. 4A is schematic plan view of a dispensing system arrangement of a fire suppression system in accordance with a third embodiment;

FIG. 4B is a schematic side view of the dispensing system arrangement of the fire suppression system of FIG. 4A;

FIG. 4C is a schematic front view of the dispensing system arrangement of the fire suppression system of FIG. 4A;

FIG. 5A is schematic plan view of a dispensing system arrangement of a fire suppression system in accordance with a fourth embodiment;

FIG. 5B is a schematic side view of the dispensing system arrangement of the fire suppression system of FIG. 5A;

FIG. 5C is a schematic front view of the dispensing system arrangement of the fire suppression system of FIG. 5A;

FIG. 6A is schematic plan view of a dispensing system arrangement of a fire suppression system in accordance with a fifth embodiment;

FIG. 6B is a schematic side view of the dispensing system arrangement of the fire suppression system of FIG. 6A;

FIG. 6C is a schematic front view of the dispensing system arrangement of the fire suppression system of FIG. 6A;

FIG. 7A is schematic plan view of a dispensing system arrangement of a fire suppression system in accordance with a sixth embodiment;

FIG. 7B is a schematic side view of the dispensing system arrangement of the fire suppression system of FIG. 7A;

FIG. 7C is a schematic front view of the dispensing system arrangement of the fire suppression system of FIG. 7A;

FIG. 8 is a plot showing temperature and pressure plot versus time within a duct; and

FIG. 9 is a fire suppression process in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

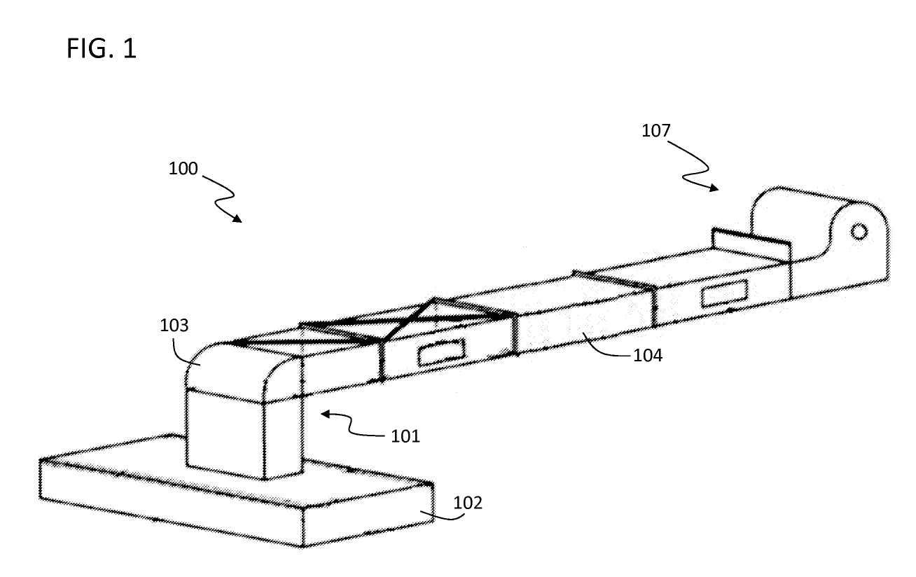

FIG. 1 is a schematic illustration of an airflow passage system, shown herein as a hood and duct system, that may employ embodiments disclosed herein. As shown, airflow system 100 includes a hood 102 at an inlet 101 of the airflow system 100 and an airflow passage 104 with a junction 103 at the inlet 101 connecting the hood 102 with the airflow passage 104. The hood 102 may be configured to be positioned over a cooktop or other area or device that may be subject to high heat temperatures. The hood 102 may collect, funnel, or direct hot air from below the hood 102 into the airflow passage 104 for evacuating the hot air from the area around the hood 102, and exhaust the air toward an outlet 107. Those of skill in the art will appreciate that the airflow system 100 may include fans, collectors, filters, etc. but these features are not shown for clarity. Further, although described herein with respect to a hood-and-duct system, those of skill in the art will appreciate that this is merely for illustrative purposes and is not to be limiting. For example, embodiments described herein may be employed in any airflow passage configurations and/or applications, and particularly may be employed in airflow passages that may be subject to fire risks.

Turning back to FIG. 1, in the event of a fire in the area surrounding the hood 102, the extreme heat from the fire may be pulled into the hood 102 and the airflow passage 104. This may cause the temperature within the airflow passage 104 to rise, thus a suppression system may be required to reduce the temperature and/or extinguish any fires within the airflow passage 104. Further, even after a suppression system may be activated at the fire, the hood 102 and airflow passage 104 may continue to pull hot air into the airflow passage 104, which may cause the temperatures to rise dramatically even after suppression has started. This may result in a fire within the airflow passage 104 to restart. Restarting of the fire may be caused by fresh air entering the hood 102 and the airflow passage 104 after a fire that is outside of the airflow system 100 is suppressed. Thus it may be advantageous to prevent any increase in temperature within the airflow passage 104 from occurring once fire suppression begins.

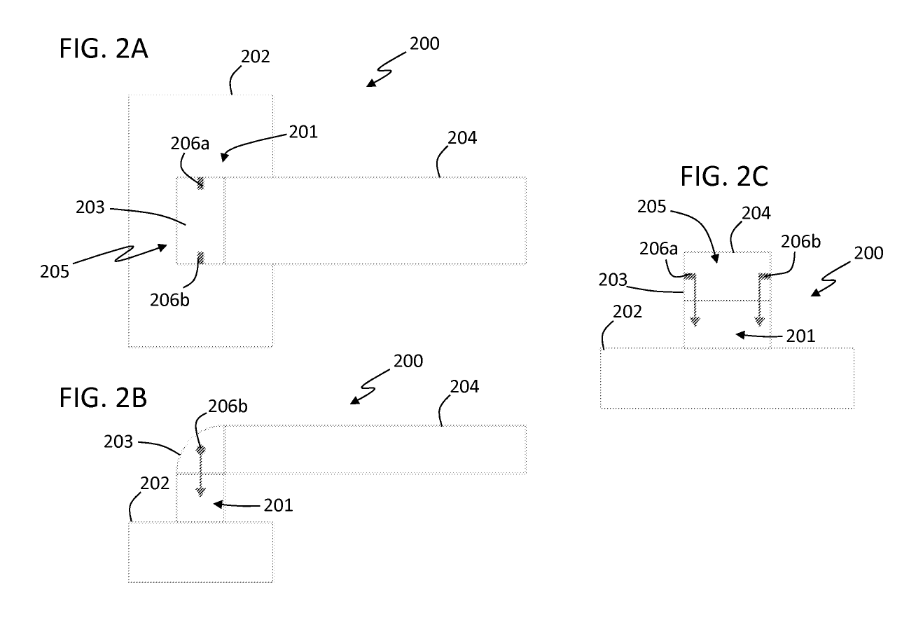

Turning to FIGS. 2A-2C, a first non-limiting embodiment of the present disclosure is shown. FIG. 2A is schematic plan view of a dispensing system arrangement of a fire suppression system in accordance with the first embodiment; FIG. 2B is a schematic side view of the dispensing system arrangement of the fire suppression system of FIG. 2A; and FIG. 2C is a schematic front view of the dispensing system arrangement of the fire suppression system of FIG. 2A.

As shown in FIGS. 2A-2C, a hood 202 and airflow passage 204, joined by a junction 203, are part of an airflow system 200. Also shown in FIGS. 2A-2C is a dispensing system 205 located within the junction 203. The dispensing system 205 may include two passage-inlet nozzles 206a, 206b. The passage-inlet nozzles 206a, 206b are configured as part of a fire suppression system, which may include other nozzles, dispensers, sensors, etc. As shown in FIGS. 2B and 2C, an arrow indicates that direction the nozzles are configured to dispense or direct a fluid flow. That is, the passage-inlet nozzles 206a, 206b are configured to direct a fluid downward or in the direction from the airflow passage 204 toward an inlet 201. Further, the passage-inlet nozzles 206a, 206b are positioned proximal or near the inlet 201 of the airflow passage 204 relative to the hood 202, i.e., as shown, in the junction 203, such that any fluid dispensed from the passage-inlet nozzles 206a, 206b may be provided at the beginning of any airflow into the airflow passage 204.

In accordance with some embodiments, the dispensing system 205 may be fluidly connected to a fluid source, such as a water source (not shown). Further, the dispensing system 205 may be electrically or mechanically controlled by a fire suppression system controller, as known in the art. Alternatively, the dispensing system 205 may be configured to dispense a water mist when a predetermined temperature is sensed by the dispensing system 205. That is, in some embodiments, the dispensing system 205 may automatically dispense a fluid, such as water, when a predetermined temperature around the dispensing system 205 is reached.

In operation, when a fire suppression event is triggered, the dispensing system 205 may dispense a water mist discharge or a water mist curtain toward and at the inlet 201, e.g., into the hood 202, from the airflow passage 204. In some embodiments, the two passage-inlet nozzles 206a, 206b of the dispensing system 205 are configured to spray or dispense the water in a distribution to provide a blockage with a formed water mist discharge that is directed in a direction against ventilation into the airflow passage 204. That is, air flows into the hood 202 and then into the airflow passage 204, and at the same time, water mist is dispensed from the airflow passage 204 toward the hood 202. The counter or contra flow of water mist into the airflow may disrupt or hinder the flow of air into the airflow passage 204. Further, the water mist dispensed by the passage-inlet nozzles 206a, 206b may keep temperatures within the airflow passage 204 low, thus further preventing fires within the airflow passage 204. Moreover, the water mist dispensed from the passage-inlet nozzles 206a, 206b may operate to extinguish a fire that may be within the airflow passage 204.

A distribution of the water mist discharge may be achieved by the positioning of the dispensing system 205. In accordance with some embodiments, and as shown in FIGS. 2A-2C, a first passage-inlet nozzle 206a may be located or positioned on a first side of the airflow passage 204 proximal to or at the inlet 201 and a second passage-inlet nozzle 206b may be located or positioned on a second side of the airflow passage 204 opposite from the first passage-inlet nozzle 206a. The two passage-inlet nozzles 206a, 206b can adequately and efficiently provide a water mist discharge that is sufficient to disrupt the airflow into the airflow passage 204 during a fire in the airflow passage 204, and thus efficiently suppress the fire, maintain relatively cool temperatures within the airflow passage 204, and prevent any restarting of a fire within the airflow passage 204.

As will be appreciated by those of skill in the art, additional airflow passage nozzles may be configured within the airflow passage of the airflow system to further aid in the suppression of a fire within the airflow passage. For example, non-limiting embodiments are described below, wherein various airflow passage nozzle configurations are shown and described. As will be apparent from each of the following example, non-limiting embodiments, the passage-inlet nozzles described above are provided in each configuration and are oriented to dispense or supply a water mist from the airflow passage at the inlet and thus disrupt airflow into the airflow passage.

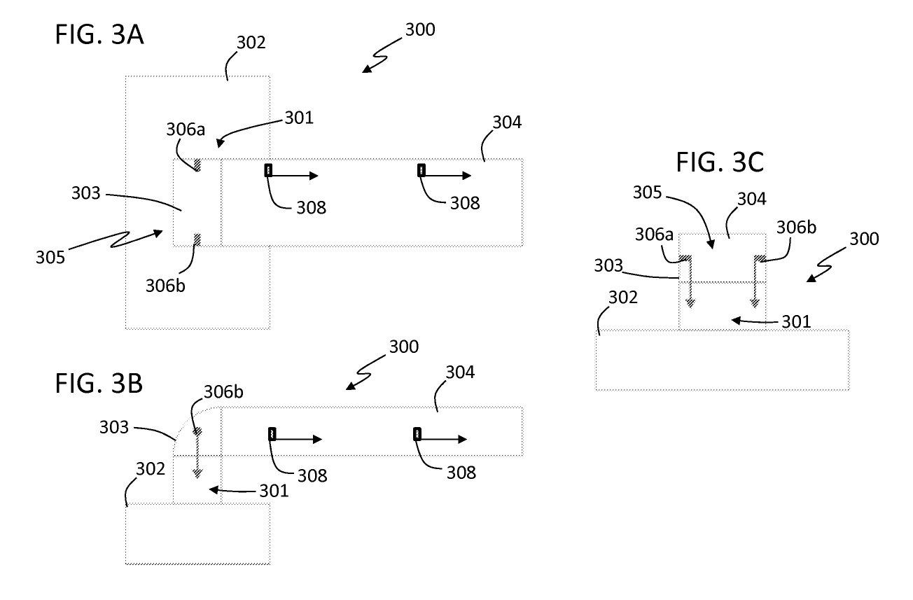

In the embodiment of FIGS. 3A-3C, an airflow system 300 is shown. The airflow system 300 includes a hood 302 and an airflow passage 304 connected by a junction 303, similar to that described above. A dispensing system 305 includes two passage-inlet nozzles 306a, 306b positioned at the end of the airflow passage 304 that is adjacent or connected to the hood 302 and are oriented to dispense a water mist discharge from the airflow passage 304 toward the inlet 301. Located within the airflow passage 304 are one or more airflow passage nozzles 308. In the embodiment of FIGS. 3A-3C, the airflow passage nozzles 308 are configured to dispense water in the direction of the ventilation or air flow, i.e., away from the inlet 301. The airflow passage nozzles 308 may be configured to supply water mist into the airflow passage 304 to extinguish any fires within the airflow passage 304. As described above, the passage-inlet nozzles 306a, 306b are configured to disrupt air flow as it enters the airflow passage 304 at the inlet 301.

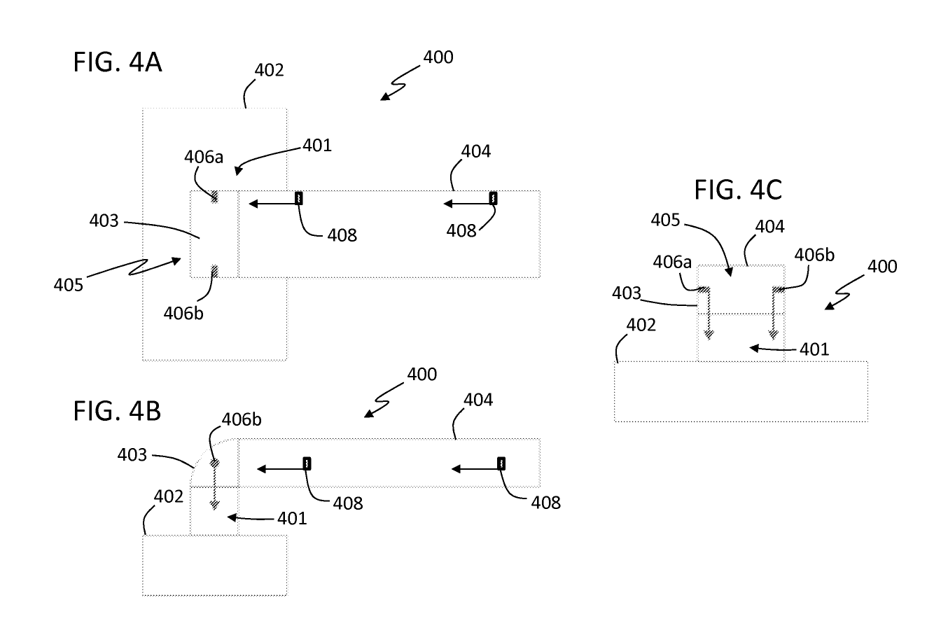

In the embodiment of FIGS. 4A-4C, airflow system 400 is shown. The airflow system 400 includes a hood 402 and an airflow passage 404 connected by a junction 403, similar to that described above. A dispensing system 405 includes two passage-inlet nozzles 406a, 406b positioned at the inlet 401 of the duct 404 that is adjacent or connected to the hood 402 and are oriented to dispense a water mist from the airflow passage 404 toward the hood 402. Located within the airflow passage 404 are one or more airflow passage nozzles 408. In the embodiment of FIGS. 4A-4C, the airflow passage nozzles 408 are configured to dispense water in a direction counter to the ventilation or air flow, i.e., toward the inlet 401. The airflow passage nozzles 408 may be configured to supply water mist into the airflow passage 404 to extinguish any fires within the airflow passage 404. The passage-inlet nozzles 406a, 406b are configured to disrupt air flow as it enters the airflow passage 404 at the inlet.

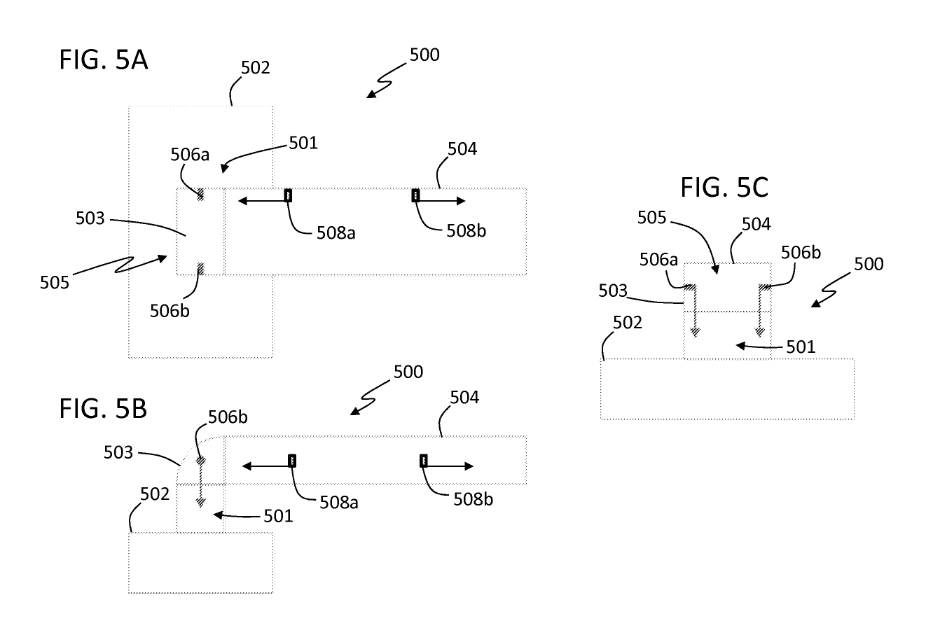

In the embodiment of FIGS. 5A-5C, an airflow system 500 is shown. The airflow system 500 includes a hood 502 and an airflow passage 504 connected by a junction 503, similar to that described above. A dispensing system 505 includes two passage-inlet nozzles 506a, 506b positioned at the inlet 501 of the airflow passage 504 that is adjacent or connected to the hood 502 and are oriented to dispense a water mist from the airflow passage 504 toward the inlet 501. Located within the airflow passage 504 are airflow passage nozzles 508a, 508b. In the embodiment of FIGS. 5A-5C, the airflow passage nozzles 508a, 508b are configured to dispense in opposite directions. That is, a first airflow passage nozzle 508a may be configured to dispense water in a direction toward the inlet 501, i.e., contra-airflow, and a second airflow passage nozzle 508b may be configured to dispense water in a ventilation direction, i.e., further into the airflow passage 504. The airflow passage nozzles 508a, 508b may be configured to supply water mist into the airflow passage 504 to extinguish any fires within the airflow passage 504. The passage-inlet nozzles 506a, 506b are configured to disrupt air flow as it enters the airflow passage 504 at the inlet 501.

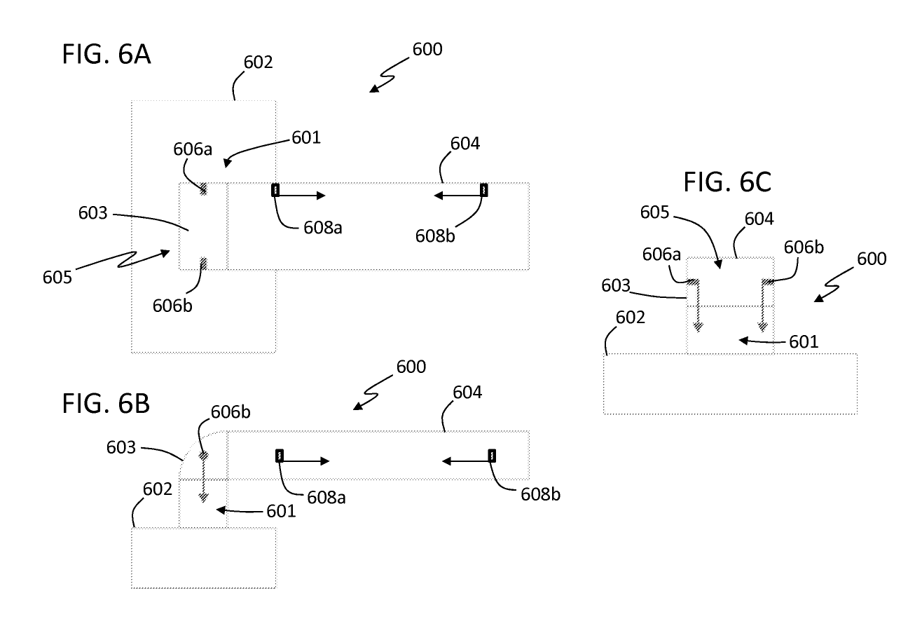

In the embodiment of FIGS. 6A-6C, an airflow system 600 is shown. The airflow system 600 includes a hood 602 and an airflow passage 604 connected by a junction 603, similar to that described above. A dispensing system 605 includes two passage-inlet nozzles 606a, 606b positioned at the end of the airflow passage 604 that is adjacent or connected to the hood 602 and are oriented to dispense a water mist from the airflow passage 604 toward the inlet 601. Located within the airflow passage 604 are airflow passage nozzles 608a, 608b. In the embodiment of FIGS. 6A-6C, the airflow passage nozzles 608a, 608b are configured to dispense in opposite directions. That is, a first airflow passage nozzle 608a may be configured to dispense water in a ventilation direction, i.e., further into the airflow passage 604 and a second airflow passage nozzle 608b may be configured to dispense water in a direction toward the inlet 601, i.e., contra-airflow. The airflow passage nozzles 608a, 608b may be configured to supply water mist into the duct 604 to extinguish any fires within the airflow passage 604. The passage-inlet nozzles 606a, 606b are configured to disrupt air flow as it enters the airflow passage 604 at the inlet 601.

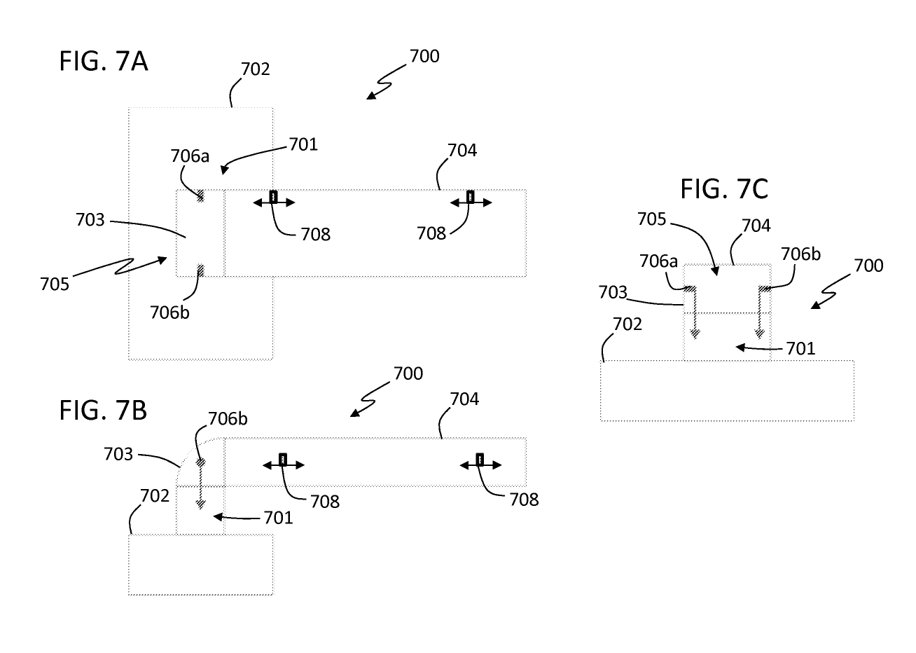

In the embodiment of FIGS. 7A-7C, an airflow system 700 is shown. The airflow system 700 includes a hood 702 and an airflow passage 704 connected by a junction 703, similar to that described above. A dispensing system 705 includes two passage-inlet nozzles 706a, 706b positioned at the end of the airflow passage 704 that is adjacent or connected to the hood 702 and are oriented to dispense a water mist from the airflow passage 704 toward the hood 702. Located within the airflow passage 704 are one or more airflow passage nozzles 708. In the embodiment of FIGS. 7A-7C, the airflow passage nozzles 708 are configured to dispense water in two directions simultaneously. That is, the airflow passage nozzles 708 are configured to dispense water in a direction counter to the ventilation or air flow, i.e., toward the inlet 701 and in a ventilation direction, i.e., further into the airflow passage 704. The airflow passage nozzles 708 may be configured to supply water mist into the airflow passage 704 to extinguish any fires within the airflow passage 704. The passage-inlet nozzles 706a, 706b are configured to disrupt air flow as it enters the airflow passage 704 at the inlet 701. In some non-limiting embodiments, the two passage-inlet nozzles 706a, 706b may be configured to dispense a water mist discharge in both directions, i.e., toward the inlet and toward the outlet, at the airflow passage inlet.

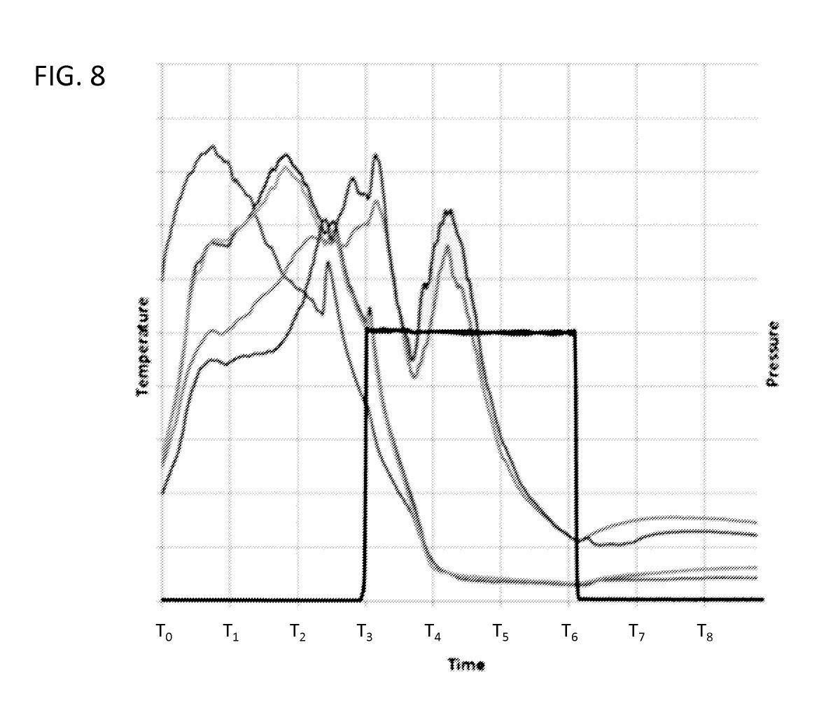

Turning now to FIG. 8, a temperature and pressure plot, versus time, is shown. The plot of FIG. 8 shows the temperature profile in an airflow passage of an airflow system that does not employ a configuration as described herein. That is, the plot represents an airflow system that does not include a dispensing system, e.g., having two passage-inlet nozzles, as described above. Starting at the origin, time progresses to the right. If a fire starts at time T₀, high temperatures exist until fire suppression occurs around time T₃. After time T₃ the temperature significantly drops. However, around time T₄, the temperature rises again. This may occur because fresh oxygen or air may enter the airflow passage and the fire may re-ignite. As the suppression continues, the fire will eventually be extinguished, and the temperatures will drop again.

In contrast to the plot shown in FIG. 8, airflow systems equipped with embodiments disclosed herein may prevent the increase in temperature after fire suppression has begun. This is achieved by the positioning and orientation of the dispensing system, such as two passage-inlet nozzles as described above. A water mist discharge generated by the dispensing system may disrupt the airflow of air into the airflow passage, and thus prevent a sufficient supply of oxygen that may result in a restarting of the fire. Further, the water mist discharge generated by the dispensing system may add sufficient moisture into the air to maintain low temperatures and may also add to the suppression and extinguishing of a fire within the airflow passage.

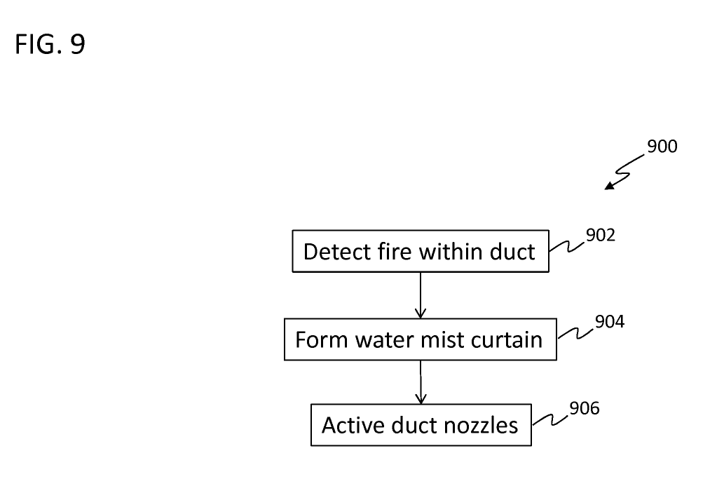

Turning now to FIG. 9, a fire suppression process in accordance with an embodiment of the present disclosure is shown. Process 900 may be performed by any of the above described dispensing system configurations of airflow systems or variations thereof. The process begins when a fire or high temperatures are detected within an airflow passage of an airflow system (step 902). The detection may be made by any number and/or type of sensors. For example, smoke detectors, infrared sensors, and/or other types of detectors and/or sensors may be employed to determine that a fire or excessive temperatures are present in an airflow passage.

When a fire or high temperatures are detected (step 902), a suppression or dispensing system may be activated or actuated. One step, in accordance with the present disclosure, is the generation of a water mist discharge in or at the inlet of the airflow system (step 904). For example, in some embodiments, the water mist discharge may be formed by activation of two passage-inlet nozzles. The passage-inlet nozzles may be configured as two nozzles positioned proximate to or near the inlet or at a connection between the airflow passage and a device or element at the inlet of the airflow passage. Further, the two nozzles may be oriented to disperse or spray a water mist from the airflow passage toward the inlet to form the water mist discharge. In some embodiments, the water mist discharge may be a uniform distribution of water mist that is sufficient to disrupt airflow into the duct. Further, in some embodiments, the water mist discharge may be both dispensed toward and away from the inlet, depending on the configuration of the system

Additionally, airflow passage nozzles, or nozzles located within the airflow passage, may be activated (step 906). The airflow passage nozzles may be configured to dispense or spray water in any desired or predetermined direction (with the airflow or contraflow or combinations thereof).

As will be appreciated by those of skill in the art, the order of steps 904 and 906 may be simultaneous or may occur in any temporal order. Thus, in some embodiments the water mist discharge may be generated at the same time that the airflow passage nozzles are activated. In other embodiments the airflow passage nozzles may be activated first to provide a fire extinguishing supply of water or other material, which may then be followed by the generation of the water mist discharge to prevent subsequent rises in temperature within the airflow passage. In other embodiments, the order may be as shown in FIG. 9, wherein the water mist discharge is activated first, followed by the airflow passage nozzles being activated.

Advantageously, embodiments described herein provide an effective fire suppression system that prevents temperature increases after fire suppression begins. Further, advantageously, embodiments described herein provide two nozzles located in an airflow passage near an inlet of an airflow system that are oriented to dispense water mist from the airflow passage toward the inlet. Advantageously, a water mist discharge may be formed at or near an inlet of an airflow passage by the nozzle configurations described herein to disrupt airflow into the airflow passage. The disruption of airflow may prevent oxygen from entering the airflow passage and thus restarting a fire, further the water mist discharge may assist in maintaining low temperatures in the air in the airflow passage, and moreover, the water mist may assist in extinguishing any fires within the airflow passage. Moreover, advantageously, embodiments disclosed herein may combine passage-inlet nozzles as described with airflow passage nozzles to provide efficient and effective fire suppression and extinguishing systems.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although described as a dispensing system having two passage-inlet nozzles positioned above the inlet to the airflow passage, those of skill in the art will appreciate that other numbers and configurations of passage-inlet nozzles or dispensers may be used without departing from the scope of the disclosure. For example, in some embodiments a hose or continuous dispenser may be configured about the inlet of the airflow passage and configured to dispense water mist to form a water mist discharge in the inlet of the airflow passage. Further, for example, a single high powered, wide-spread dispenser or passage-inlet nozzle may be configured at the center of the airflow passage above the inlet to provide a water mist discharge.

Accordingly, the present disclosure is not to be seen as limited by the foregoing description, but is only limited by the scope of the appended claims.

1. A fire suppression system of an airflow system comprising:
an airflow passage having an inlet and an outlet configured to provide an airflow path from the inlet to the outlet to exhaust air therethrough; and
a dispensing system located within the airflow passage proximal to the inlet and configured to dispense a water mist discharge from within the airflow passage toward the inlet to form a water mist discharge sufficient to disrupt an airflow into the airflow passage.

2. The fire suppression system of claim 1, wherein the dispensing system comprises two passage-inlet nozzles located within the airflow passage and oriented to dispense the water mist discharge toward the inlet of the airflow passage.

3. The fire suppression system of claim 1, further comprising at least one airflow passage nozzle located within the airflow passage downstream of the inlet and configured to dispense water into the airflow passage.

4. The fire suppression system of claim 3, wherein the at least one passage-inlet nozzle is oriented to dispense water toward the inlet of the airflow passage.

5. The fire suppression system of claim 3, wherein the at least one passage-inlet nozzle is oriented to dispense water away from the inlet of the airflow passage.

6. The fire suppression system of claim 3, wherein the at least one passage-inlet nozzle comprises a first passage-inlet nozzle and a second passage-inlet nozzle, wherein the first passage-inlet nozzle is oriented to dispense water toward the inlet of the airflow passage and the second passage-inlet nozzle is oriented to dispense water away from the inlet of the airflow passage.

7. The fire suppression system of claim 3, wherein the at least one passage-inlet nozzle is oriented to dispense water toward both the inlet and the outlet of the airflow passage.

8. The fire suppression system of claim 1, further comprising a hood located external to the airflow passage at the inlet.

9. A method of suppressing a fire within an airflow passage, the method comprising:
detecting a fire within an airflow passage;
activating a dispensing system; and
dispensing a water mist discharge at least one of toward and away from an inlet of the airflow passage from within the airflow passage to form a water mist discharge sufficient to disrupt an airflow into the airflow passage,
wherein the dispensing system is located proximal to the inlet of the airflow passage.

10. The method of claim 9, wherein the dispensing system comprises two passage-inlet nozzles located proximal to the inlet and oriented to dispense the water mist discharge.

11. The method of claim 9, further comprising dispensing water into the airflow passage from at least one airflow passage nozzle located within the airflow passage.

12. The method of claim 11, wherein the at least one passage-inlet nozzle is oriented to dispense water toward the inlet.

13. The method of claim 11, wherein the at least one passage-inlet nozzle is oriented to dispense water away from the inlet.

14. The method of claim 11, wherein the at least one passage-inlet nozzle comprises a first passage-inlet nozzle and a second passage-inlet nozzle, wherein the first passage-inlet nozzle is oriented to dispense water toward the inlet and the second passage-inlet nozzle is oriented to dispense water away from the inlet.

15. The method of claim 11, wherein the at least one passage-inlet nozzle is oriented to dispense water both toward the inlet and away from the inlet.
